(19) United States
(12) Patent Application Publication
(10) Pub. No.: US 2011/0296760 A1
(43) Pub. Date: Dec. 8, 2011

(54) Security Window Assembly

(76) Inventors: Robert Auston, Plantation, FL (US); Gloria Auston, Plantation, FL (US)

(21) Appl. No.: 13/155,352

(22) Filed: Jun. 7, 2011

Related U.S. Application Data
(60) Provisional application No. 61/352,635, filed on Jun. 8, 2010.

(51) Int. Cl. E06B 9/01; E06B 3/42

(52) U.S. Cl. 49/54

(57) ABSTRACT

A security window assembly includes a frame coupled to an opening in a structure, a first window section coupled to the frame, and a second window section slidable within the frame relative to the first window section, where the second window section has a closed position where the first window section and the second window section substantially fill different portions of the opening and an open position where the first window section and the second window section substantially fully overlap each other. A security panel is coupled to the second window section so that the security panel is stowed within the structure when the second window section is in the closed position and at least partially fills the opening when the second window section is in the open position.

### CROSS-REFERENCE TO RELATED APPLICATIONS

This application claims priority under 35 U.S.C. §.119(e) based on U.S. Provisional Patent Application Ser. No. 61/352,635, filed June 08, 2010, the contents of which are relied upon and incorporated herein by reference in their entirety.

### FIELD OF THE INVENTION

The present invention relates generally to security windows, and more particularly relates to security windows with security bars that slide out of view when a window is closed and automatically slide into position to protect an opening when the window is open.

### BACKGROUND OF THE INVENTION

Security, whether of personal or property, is at the forefront of many people's minds. One commonly-known way of protecting one's person and possessions is by equipping the windows of the house with security bars. Security bars are generally a number of metal members arranged across an opening of a house that prevent entrance into the house by unauthorized persons or animals.

However, placing bars on a window has major disadvantages. For one, because the bars are for security, there is never a safe time to remove them. Even if there was, the bars are generally secured with heavy bolts or anchors into the exterior of the house making removal and installation a difficult and time-consuming task. Therefore, the permanently-installed bars, which are always visible from a Street view, render the outside of the home unsightly.

Another disadvantage of placing bars across window openings is that they prevent the inhabitants of the dwelling from exiting through the window opening, which may create a dangerous situation in times of emergency. For instance, if a fire were to be present within the home, inhabitants would be unable to exit the home through a window protected by bars.

An alternative to protecting a home with bars is simply leaving a window closed and locked. This is particularly effective when “impact” glass is used, which is virtually impossible to penetrate, even when the glass breaks. However, anytime the window is open or unlocked, the home becomes susceptible to intruders. Also, the homeowner is completely dependent upon air-conditioning if they cannot open their windows to allow a breeze to pass through the openings.

Therefore, a need exists to overcome the problems with the prior art as discussed above.

### SUMMARY OF THE INVENTION

The invention provides a security window that overcomes the hereinafore-mentioned disadvantages of the heretofore-known devices and methods of this general type and that provides a set of bars attached to a lower sill of a movable window, where the bars advantageously hide within a portion of the wall when the window is closed and automatically slide upwards or sideways and into position when the window is open, providing security and allowing a comfortable flow of air throughout the housing structure.

In some embodiments of the present invention, the security bars are detachable from the window which allows the inhabitants of the structure to exit through an opening when desired.

With the foregoing and other objects in view, there is provided, in accordance with the invention, a security window assembly includes a frame, a first window section coupled to the frame, a second window section slidable within the frame relative to the first window section, and a security panel coupled to the second window section and slidable relative to the first window section, the security panel defining at least one aperture allowing air to pass to from a first side of the security panel to a second side opposite the first side.

In accordance with a further feature of the present invention the second window section is slidable from a closed window position to an open window position.

In accordance with another feature of the present invention, when the second window section is in the open window position, the security panel is in the closed window position.

In accordance with one more feature, an embodiment of the present invention includes a plurality of security bars or a security screen on the security panel.

In accordance with a yet another feature of the present invention, the security panel is substantially in a plane defined by either the four edges of the first window section or a plane defined by the four edges of the second window section.

In accordance with an additional feature of the present invention, the security panel is selectively decouplable from the second window section.

In accordance with one more feature, an embodiment of the present invention includes a coupler on a first side of the security window assembly and selectively coupling the security panel to the second window section and a flange at least partially covering the coupler, thereby preventing access to the coupler by a person when on a second side of the security window assembly opposite the first side.

In accordance with yet another feature, an embodiment of the present invention includes a security window assembly with a frame coupled to an opening in a structure, a first window section coupled to the frame, and a second window section slidable within the frame relative to the first window section, where the second window section has a closed position where the first window section and the second window section substantially fill different portions of the opening and an open position where the first window section and the second window section substantially fully overlap each other. A security panel is coupled to the second window section so that the security panel is stowed within the structure when the second window section is in the closed position and at least partially fills the opening when the second window section is in the open position.

In accordance with another feature, an embodiment of the present invention also includes a security window assembly the includes a frame defining a frame opening, a first window section secured to the frame and occupying a first portion of the frame opening, and a second. window section slidably secured to the frame and slidable relative to the first window section. The second window section has a closed position where the second window section occupies a second portion of the opening different from the first portion of the opening with the first window section and the second window section substantially filling the entire frame opening and an open position where the first window section and the second window section substantially overlap and occupy the first portion of the frame opening. A security panel is coupled to the second window section so that the security panel is outside of the frame when the second window section is in the closed position and at least partially fills the second portion of the opening when the second window section is in the open position.

Although the invention is illustrated and described herein as embodied in a security window, it is, nevertheless, not intended to be limited to the details shown because various modifications and structural changes may be made therein without departing from the spirit of the invention and within the scope and range of equivalents of the claims, Additionally, well-known elements of exemplary embodiments of the invention will not be described in detail or will be omitted so as not to Obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure, Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the term “about” or “approximately” applies to all numeric values, whether or not explicitly indicated, These terms generally refer to a range of numbers that one of skill in the art would consider equivalent to the recited values having the same function or result). In many instances these terms may include numbers that are rounded to the nearest significant figure. In this document, the term “longitudinal” should be understood to mean in a direction corresponding to an elongated direction of the longest dimension of the structure being described.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an elevational view of a window in a closed position with security bars being hidden within a wall, in accordance with the present invention;

FIG. 2 is an elevational view of the window of FIG. 1 in an open position showing the security bars in a securing position, in accordance with the present invention;

FIG. 3 is an elevational view of a horizontally-moving window in a closed position with security bars hidden from view within a wall, in accordance with the present invention;

FIG. 4 is an elevational view of the horizontally-moving window of FIG. 3 in an open position showing the security bars in a securing position, in accordance with the present invention;

FIG. 5 provides an elevational edge view of a security window with decouplable security bars and a protective flange to prevent unauthorized decoupling, in accordance with the present invention; and

FIG. 6 provides a perspective view of the decouplable security window of FIG. 5.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel an efficient security window with security bars that automatically slide into position when the two-part window is open and automatically hide within a wall when the two-part window is closed. In addition, embodiments of the invention provide windows that are not necessarily two-part windows but still provide automatic positioning of the security bars as described herein.

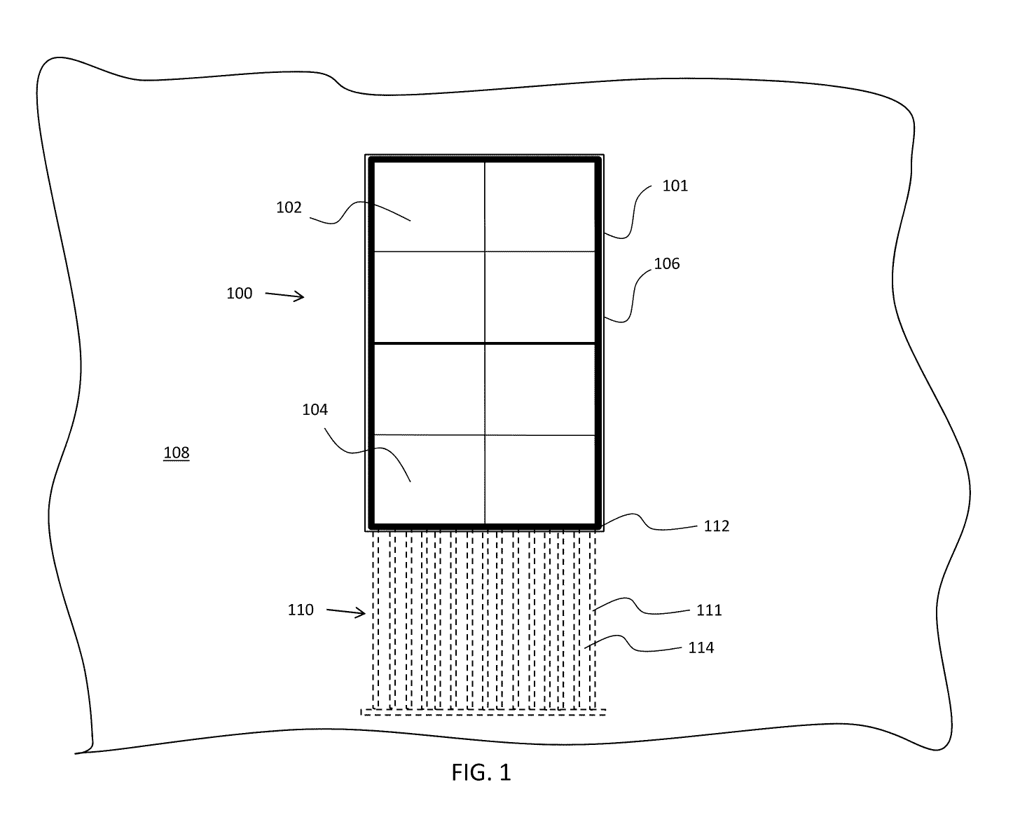

Referring now to FIG. 1, one embodiment of the present invention is shown in an elevational view, FIG. 1 shows several advantageous features of the present invention, but, as will be described below, the invention can be provided in several shapes, sizes, combinations of features and components, and varying numbers and functions of the components. The first example of a security window, as shown in FIG. 1, includes a security window assembly 100 having a frame 101, a first part 102 and a second part 104, both supported by the frame 101 that is placed within an opening 106 within a wall 108. The wall 108 represents an exterior of the house, a building, or any other structure where windows might be found. It should be noted, the present invention is not limited to exterior walls.

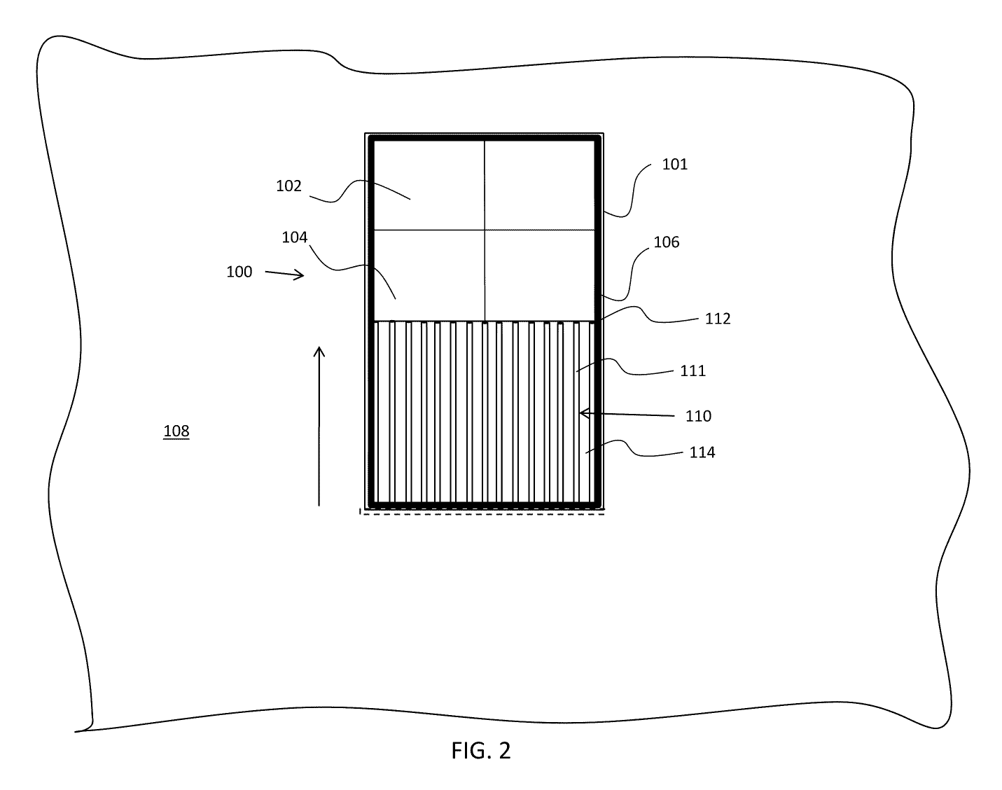

In the particular example of a security window assembly 100 shown in FIG. 1, the first window part 102 is in a fixed position while the second window part 104 is salable between an open and closed position. FIG, 1 shows the second window part 104 in the closed position while FIG, 2 shows the second window part 104 in the open position. FIG. 2 will be discussed in detail below, With reference still to FIG. 1, the second window part 104 has attached thereto a security panel 110. The security panel 110 includes any structure that is able to prevent a person from passing through an opening while allowing air to pass through. In this embodiment, the security panel 110 includes a plurality of bars 111 that define apertures 114 between the bars 111 that allow air to permeate from one side of the security window assembly 100 to the other, i.e., from outside a structure to the inside of the structure. In FIG. 1, the bars 111 are represented with dashed lines to indicate that the bars 111 are hidden within the wall 108. In one embodiment of the present invention, the bars 111 are secured to the bottom edge 112 of the second part 104 of the security window assembly 100 and move in conjunction with the second. part 104 of the security window assembly 100 as it is opened and closed.

As shown in FIG. 1, the security window assembly 100, when in the closed position, appears from the street as a normal window. That is, the security panel 110 is completely hidden and out of view to the ordinary observer. The security window assembly 100, when the second window part 104 is in the closed position, provides security as does any other closed window. If the window were made of, for instance, impact glass, even greater security can be realized simply by closing the security window assembly 100.

Referring now to FIG. 2, the security window assembly 100 is shown in the open position. That is, the second window part 104 of the security window assembly 100 has been raised. As the security panel 110 is attached to the lower portion 112 of the second part 104 of the security window assembly 100, the bars 111 have been raised as well. While in this open position shown in FIG. 2, the security bars 111 prevent entrance by any person or creature into the structure being protected by the security window assembly 100, Advantageously, air is allowed to pass through the opening 106 while the opening 106 is being secured by the bars 111. The security panel 110 can include structures of any material with sufficient strength to prevent of inhibit an intruder from entering the opening 106. It should be noted that the present invention is not limited to bars 111. The bars 111 can be replaced with, for example, a screen material with sufficient strength to prevent of inhibit an intruder from entering the opening 106.

The present invention has the advantage of being easily installed in the area within the wall directly below the security window assembly 100, as often the wall 108 is hollow and already able to accept the security panel 110, or can be easily hollowed out by the builder or installer so that it is able to accept the security panel 110 and to allow the security panel 110 to slide up and down within the wall.

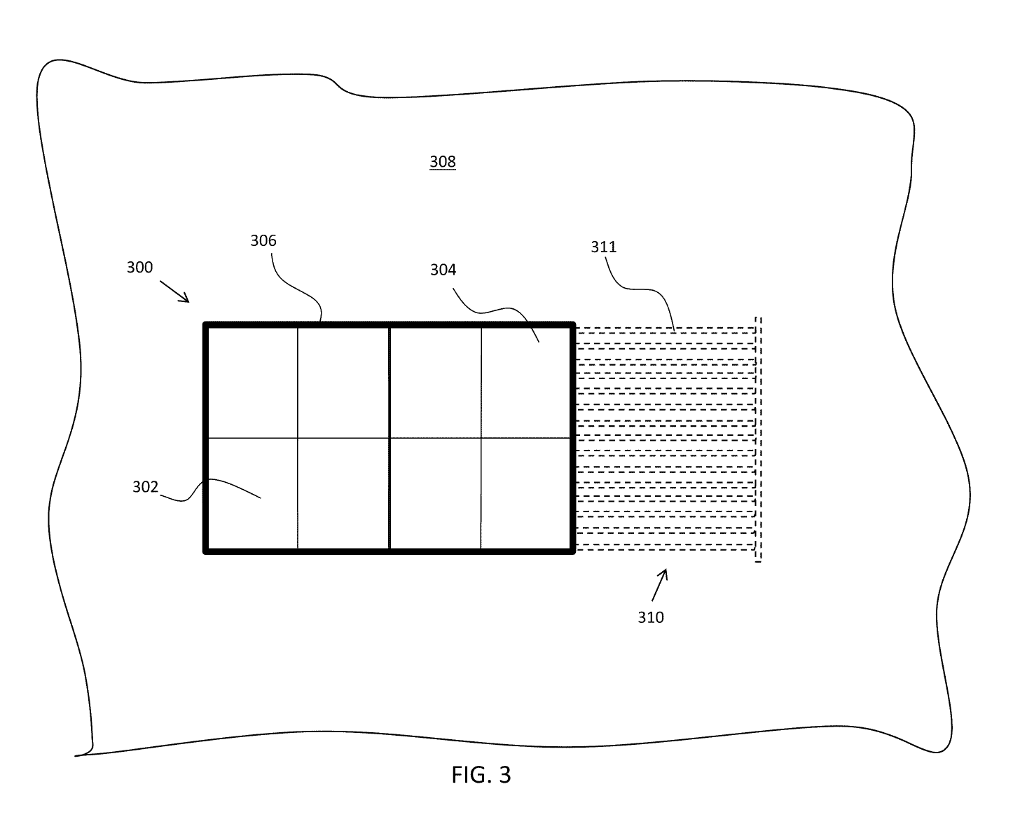

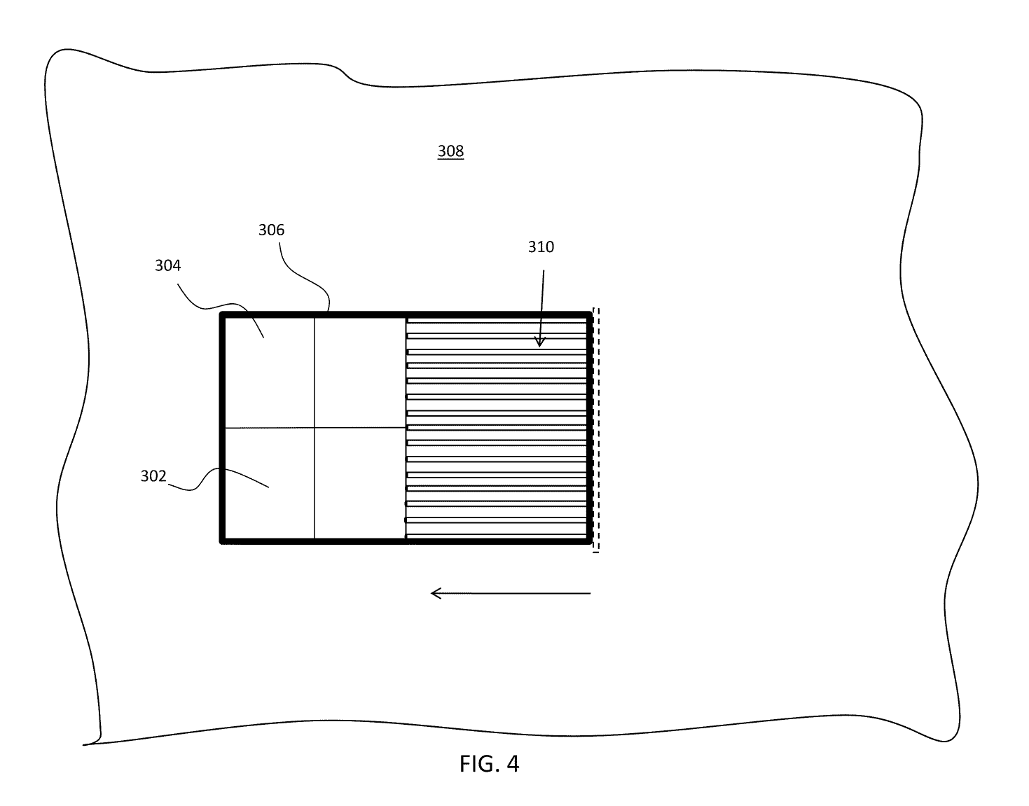

FIG. 3 shows a second embodiment of the present invention where at least one part of a security window assembly 300 within an opening 306 slides horizontally rather than vertically, as was illustrated in FIGS. 1 and 2. Horizontally sliding windows are particularly prevalent areas such as Florida where homes are protected with impact, i.e., “hurricane” glass, which is considerably heavier than regular glass and renders a window difficult to open in a vertical direction. In the embodiment shown in FIG. 3, similar to the embodiment shown in FIGS. 1 and 2, when the security window assembly 300 is closed, the security panel 310, which includes a plurality of bars 311, is hidden within the wall 308. Similarly, as shown in FIG. 4 when the security window assembly 300 is open, i.e., the second window part 304 is slid relative to the first window part 302, the security panel 310 slides out of the wall 308 and into position. That is, the security panel 310 goes from being hidden within the wall 308 and not visible to a viewer, to protecting the opening 306 and being completely viewable, Of course, if the bars 311 are of a clear or transparent material, such as LEXAN or acrylic glass, the security panel 310 might not be entirely visible from the street.

In each of the embodiments described herein and shown in the accompanying figures, the window opening 106, 306 is at all times protected by the security window assembly 100, 300. Advantageously, the inventive security window assembly 100, 300, unlike the prior art security bars, does not require continuous installation of the security bars 111, 311 to provide security and un-installation when greater aesthetics are desired.

In accordance with an additional feature of the present invention, the security bars can be quickly decoupled from the second window part and allow occupants of the structure being protected by the security window assembly to readily exit the structure through the opening, This decoupling can provide a tremendous advantage over prior-art secure bars that are permanently installed over window openings. For instance, in the event of a fire, inhabitants of the building protected by the present invention can quickly detach the security panel 110, 310 and exit the building through the window opening 106, 306.

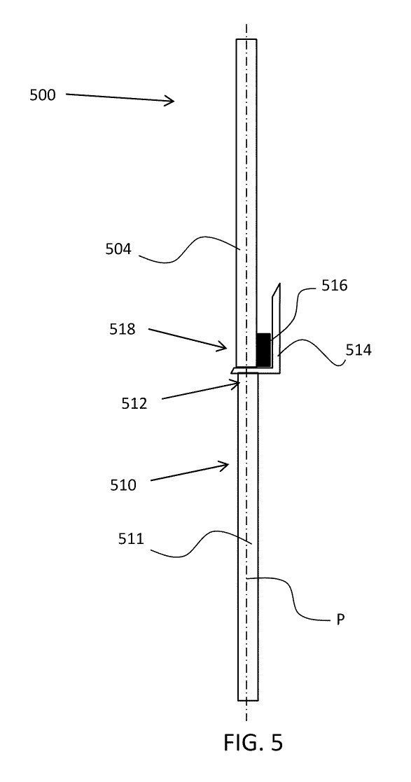

FIG. 5 shows a side elevational view of one exemplary embodiment for removably coupling a security panel 510 to a lower part 504 of a two-part window 500. The side elevational view shows that the security panel 510 is substantially in a plane P defined by the edges of the second window section 504. In the embodiment shown, the security panel 510 has an upper portion 512 that includes a flange 514. The flange 514 is present on an interior side of the window and projects upward to obscure a coupling clip 516 that couples the security panel 510 to a lower portion 518 of the lower part 504 of the two-part window 500.

The coupling clip 516 can be any mechanism that couples and decouples the window 500 to the security panel 510. Many such mechanisms are well known in the art and are not described in great detail here. The flange 514 advantageously makes it virtually impossible for one standing outside of a building to extend their arm between the bars 511 and reach the coupling clip 516. In this way, the bars 511 provide security to the structure and prevent anyone from intruding into the structure or otherwise gaining access via the opening in the wall of the structure. However, one inside the structure can easily reach between the flange 514 and the lower part 504 of the window 500 to access the coupling clip 516, which allows the security panel 510 to slide down within the wall and create in an inhibited opening. In applications where the bars 511 are replaced with a security screen material, the flange 514 is not necessary, Alternatively, a keyed lock could be used for the coupling clip 516, thus obviating the flange 514, while continuing to provide a way of decoupling the bars 511 from the lower part. 504 of the two-part window 500.

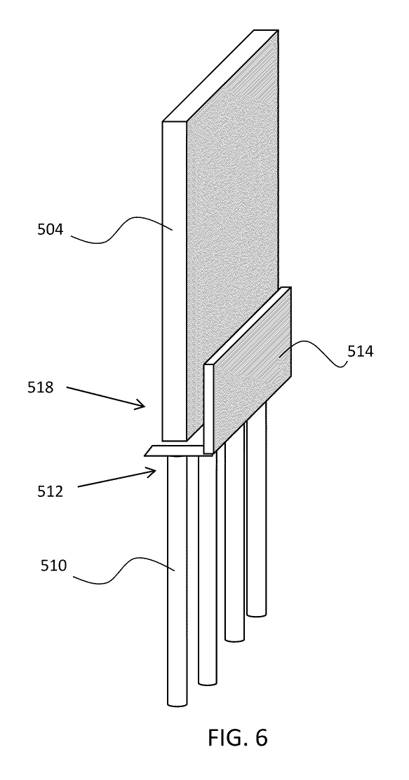

FIG. 6 provides a perspective view of the decouplable security window of FIG. 5 showing the flange 514 obscuring the coupling clip 516 and rendering the coupling clip 516 inaccessible to one positioned outside the window, i.e., on a side of the window opposite the flange 514.

A security window assembly has been disclosed that is configurable, aesthetically pleasing, and provides instant and easy security to an open window while also allowing access through an opening in the wall of the structure when desired.

It should be noted, that the present invention is not limited to use only as a safety device for keeping intruders out of a structure. The security window assembly of the present invention can be used in many other applications. For instance, the inventive security window assemblies described herein can be used in upper story windows. For example, in high rise apartment buildings where falling out of the window is a prevalent danger. By equipping the upper story openings with the security window assembly described herein, persons, such as young children, or even pets, will be prevented from falling through the opening protected by the security bars of the security window assembly when the security window assembly 100 is in an open position, as shown in FIG. 2.

What is claimed is:

1. A security window assembly comprising:
a frame;
a first window section coupled to the frame;
a second window section slidable within the frame relative to the first window section; and
a security panel coupled to the second window section and slidable relative to the first window section, the security panel defining at least one aperture allowing air to pass to from a first side of the security panel to a second side opposite the first side.

2. The security window assembly according to claim 1, wherein:
the second window section is slidable from a closed window position to an open window position.

3. The security window assembly according to claim 2, wherein:
when the second window section is in the open window position, the security panel is in the closed window position.

4. The security window assembly according to claim 2, wherein:
when the second window section is moved to the open window position, the security panel automatically replaces the second window section in the closed window position.

5. The security window assembly according to claim 1, wherein the security panel comprises:
a plurality of security bars.

6. The security window assembly according to claim 1, wherein the security panel comprises:
a screen.

7. The security window assembly according to claim 1, wherein:
the security panel is substantially in a plane defined by one of the first window section and the second window section,

8. The security window assembly according to claim 1, wherein:
the security panel is selectively decoupleable from the second window section.

9. The security window assembly according to claim 8, further comprising:
a coupler on a first side of the security window assembly and selectively coupling the security panel to the second window section; and
a flange at least partially covering the coupler, thereby preventing access to the coupler by a person when on a second side of the security window assembly opposite the first side.

10. A security window assembly comprising:
a frame coupled to an opening in a structure;
a first window section coupled to the frame;
a second window section slidable within the frame relative to the first window section, the second window section having:
a closed position where the first window section and the second window section substantially fill different portions of the opening; and
an open position where the first window section and the second window section substantially fully overlap each other; and
a security panel coupled to the second window section so that the security panel is stowed within the structure when the second window section is in the closed position and at least partially fills the opening when the second window section is in the open position.

11. The security window assembly according to claim 10, wherein:
the structure is a wall of a building.

12. The security window assembly according to claim 10, wherein:
the security panel has at least one aperture allowing air to pass to from a first side of the security panel to a second side that is opposite the first side,

13. The security window assembly according to claim 10, wherein:
the security panel is substantially in a plane defined by one of the first window section and the second window section.

14. The security window assembly according to claim 10, wherein:
the security panel is selectively decouplable from the second window section.

15. The security window assembly according to claim 14, further comprising:
a coupler on a first side of the security window assembly and selectively coupling the security panel to the second window section; and
a flange at least partially covering the coupler, thereby preventing access to the coupler by a person when on a second side of the security window assembly opposite the first side.

16. The security window assembly according to claim 10, wherein the security panel comprises:
a plurality of security bars.

17. A security window assembly comprising:
a frame defining a frame opening;
a first window section secured to the frame and occupying a first portion of the frame opening;
a second window section slidably secured to the frame and slidable relative to the first window section, the second window section having:
a closed position where the second window section occupies a second portion of the opening different from the first portion of the opening with the first window section and the second window section substantially filling the entire frame opening; and
an open position where the first window section and the second window section substantially overlap and occupy the first portion of the frame opening; and
a security panel coupled to the second window section so that the security panel is outside of the frame when the second window section is in the closed position and at least partially fills the second portion of the opening when the second window section is in the open position.

18. The security window assembly according to claim 17, wherein the security panel comprises:
a plurality of security bars.

19. The security window assembly according to claim 17, wherein:
the security panel is selectively decouplable from the second window section.

20. The security window assembly according to claim 17, further comprising:
a coupler on a first side of the security window assembly and selectively coupling the security panel to the second window section; and
a flange at least partially covering the coupler, thereby preventing access to the coupler by a person when on a second side of the security window assembly opposite the first side.
